(19) United States
(12) Patent Application Publication
(10) Pub. No.: US 2002/0053559 A1
(43) Pub. Date: May 9, 2002

(54) Method and apparatus for fusion welding quartz using laser energy

(76) Inventors: Dmitri Nikitin, Daytona Beach Shores, FL (US); Thomas Michel, Eustis, FL (US); Vladimire Borissovskii, Lake Mary, FL (US)

Correspondence Address: Finnegan, Henderson, Farabow,, Garrett & Dunner, L.L.P., 1300 I Street, N.W., Washington, DC, 20005-3315, US

(21) Appl. No.: 09/845,418

(22) Filed: Apr. 30, 2001

Related U.S. Application Data
(63) Continuation-in-part of application No. 09/516,937, filed on Mar. 1, 2000.

(51) Int. Cl. B23K 26/32

(52) U.S. Cl. 219/121.64; 219/121.63

(57) ABSTRACT

Methods, systems, and articles of manufacture consistent with the present invention use laser energy for fusion welding a first quartz object to a second quartz object. The first quartz object and second quartz object have opposing surfaces to be fusion welded together. Once placed in a configuration where the opposing surfaces are substantially near each other, one or more laser beams are applied to one of the surfaces. As the first surface is heated by the laser energy, it become reflective as it nears a desired fusion weldable condition. Once reflective, the first surface reflects the laser energy to the opposing surface where the opposing surface is then heated to the desired fusion weldable condition. As the laser beam is bounced or reflected back and forth between the opposing surfaces, the surfaces are heated in a substantially even manner to allow for molecular fusing of the first object the second object into a single quartz workpiece.

### RELATED APPLICATIONS

This application is a continuation-in-part of U.S. patent application Ser. No. 09/516,937 entitled METHOD APPARATUS AND ARTICLE OF MANUFACTURE FOR DETERMINING AN AMOUNT OF ENERGY NEEDED TO BRING A QUARTZ WORKPIECE TO A FUSION WELDABLE CONDITION, which was filed on Mar. 1, 2000. This application is also related to several commonly owned and currently filed other applications as follows: U.S. Ser. No. ______ entitled “METHOD AND APPARATUS FOR PIERCING AND THERMALLY PROCESSING QUARTZ USING LASER ENERGY”, U.S. Ser. No. ______ entitled “METHOD AND APPARATUS FOR CREATING A REFRACTIE GRADIENT IN GLASS USING LASER ENERGY”, U.S. Ser. No. ______ entitled “METHOD AND APPARATUS FOR CONCENTRICALLY FORMING AN OPTICAL PREFORM USING LASER ENERGY”, and U.S. Ser. No. ______ entitled “METHOD AND APPARATUS FOR THERMALLY PROCESSING QUARTZ USING A PLURALITY OF LASER BEAMS.”

### BACKGROUND OF THE INVENTION

A. Field of the Invention

This invention relates to systems for quartz fusion welding and, more particularly, to systems and methods for applying laser energy to fusion weld two quartz objects together into a single quartz workpiece.

B. Description of the Related Art

One of the most useful industrial glass materials is quartz glass. It is used in a variety of industries: optics, semiconductors, chemicals, communications, architecture, consumer products, computers, and associated industries. In many of these industrial applications, it is important to be able to join two or more pieces together to make one large, uniform blank or finished part. For example, this may include joining two or more rods or tubes “end-to-end” in order to make a longer rod or tube. Additionally, this may involve joining two thick quartz blocks together to create one of the walls for a large chemical reactor vessel or a preform from which optical fiber can be made. These larger parts may then be cut, ground, or drawn down to other usable sizes.

Many types of glasses have been “welded” or joined together with varying degrees of success. For many soft, low melting point types of glass, these attempts have been more successful than not. However, for higher temperature compounds, such as quartz, welding has been difficult. Even when welding of such higher temperature compounds is possible, the conventional processes are typically quite expensive and time-consuming due to the manual nature of such processes and the required annealing times.

When attempting to weld quartz, a critical factor is the temperature of the weldable surface at the interface of the quartz workpiece to be welded. The temperature is critical because quartz itself does not go through what is conventionally considered to be a liquid phase transition as do other materials, such as steel or water. Quartz sublimates, i.e., it goes from a solid state directly to a gaseous state. Those skilled in the art will appreciate that quartz sublimation is at least evident in the gross sense, on a macro level.

In order to achieve an optimal quartz weld, it is desirable to bring the quartz to a condition near sublimation but just under that point. There is a relatively narrow temperature zone in that condition, typically between about 1900 to 1970 degrees Celsius, within which one can optimally fusion weld quartz. In other words, in that usable temperature range, the quartz object will fuse to another quartz object in that their molecules will become intermingled and become a single piece of water clear glass instead of two separate pieces with a joint. However, quartz vaporizes above that temperature range, which essentially destroys part of the quartz workpiece at the weldable surface. Thus, one of the problems in achieving an optimal quartz fusion weld is controlling how much energy is applied so that the quartz workpiece reaches a weldable condition without being vaporized.

Prior attempts to fusion weld quartz have used a hydrogen oxygen flame to apply energy to the weldable surface of the quartz workpiece. Unfortunately, most of the heat energy from the flame is lost, the heat is not uniformly applied, and a wind-tunnel effect is created that blows away sublimated quartz. Additionally, the flame is conventionally applied by hand where the welder repeatedly applies the heat and then attempts to test the plasticity of the quartz workpiece until ready for welding. This process remains problematic because it takes a very long time, wastes energy, usually introduces stresses within the weld requiring additional time for annealing, and does not avoid sublimation of the quartz workpiece.

Another possibility for heating the quartz workpiece to a fusion weldable condition is to use a temperature feedback system. However, attempts to empirically measure the temperature of the quartz workpiece as part of a feedback loop have been found to be unreliable. Physical measurements of temperature undesirably load the quartz workpiece. Those skilled in the art will appreciate that this type of physical measurement also introduces uncertainties that are characteristic with most any physical measurement but especially present in the high temperature state of quartz when near or at a fusion weldable condition.

Accordingly, there is a need for a system to apply the energy required to bring a quartz workpiece to a fusion weldable condition in a substantially even or uniform fashion, in a time efficient manner, and without sublimating the quartz workpiece or causing stress fractures. Such a system will avoid applying too much energy (which vaporizes the quartz) or applying too little energy (which creates a cold joint requiring an undesirably long annealing process).

### SUMMARY OF THE INVENTION

Methods, systems, and articles of manufacture consistent with the present invention overcome these shortcomings by using laser energy to fusion weld two quartz objects. Additionally, by bouncing or reflecting the laser beam down a channel or gap between the objects, the laser beam can be used to efficiently distribute the energy in a substantially uniform manner when fusion welding thick objects to each other. More particularly stated, a method consistent with the present invention, as embodied and broadly described herein, begins with applying laser energy to a first quartz object and a second quartz object to heat the first quartz object and the second quartz object. The laser energy may be supplied by one or multiple laser beams. The laser energy is typically applied until the first quartz object and the second quartz object are in a fusion weldable condition, which is an energy reflective state substantially near but below their sublimation point. While applying such laser energy, the laser energy is typically directed to a welding zone between the first quartz object and the second quartz object. This may be accomplished by positioning a movable welding head relative to the first quartz object and the second quartz object. The movable welding head is normally coupled to a source of the laser energy and capable of reflecting the laser energy from the source towards the welding zone. Once the laser energy is applied, a fusion weld is formed between the heated first quartz object and the heated second quartz object.

In another aspect of the present invention, as embodied and broadly described herein, the fusion welding process begins by applying laser energy (such as a laser beam) to the first quartz object. The laser energy applied to the first quartz object typically brings the first quartz object to a reflective state (e.g., a state substantially near a sublimation point for the first quartz object). After applying the laser energy to the first quartz object, the laser energy is bounced between the first quartz object and the second quartz object. More particularly stated, the laser energy is reflected to the second quartz object once the first object is in an energy reflective state. This causes the first quartz object and the second quartz object to form a fusion weld.

In still another aspect of the present invention, as embodied and broadly described herein, the fusion welding process begins by applying laser energy to a first surface on the first quartz object. A movable welding head coupled to a source of the laser energy may be positioned relative to the first surface. This directs the laser energy onto the first surface. The first surface is placed proximate to and substantially near a second surface on the second quartz object. Applying the laser energy to the first surface typically heats the first surface to a reflective state. Next, the laser energy is transferred or, more specifically is reflected, from the first surface to the second surface when the first surface reaches a reflective state. The second surface is then heated to the reflective state. Finally, the first surface and the second surface contact each other to form a fusion weld between the first quartz object and the second quartz object.

In yet another aspect of the present invention, as embodied and broadly described herein, a fusion welding apparatus includes a laser energy source capable of applying laser energy to a first quartz object and to a second quartz object when forming a fusion weld between the first quartz object and the second quartz object. The apparatus may include a welding head coupled to receive the laser energy from the laser energy source. The welding head operates to direct the laser energy to a first surface of the first quartz object. The welding head may be selectively movable relative to the first quartz object and the second quartz object. The apparatus may also include a working surface for supporting the first quartz object relative to the laser energy source.

The laser energy source may also bounce the laser energy from the first surface of the first quartz object to an opposing surface of the second quartz object when heating the first surface and the opposing surface to a desired fusion weldable condition. The desired fusion weldable condition is typically an energy reflective state substantially near but below a sublimation point for the first quartz object and the second quartz object.

### BRIEF DESCRIPTION OF THE DRAWINGS

The accompanying drawings, which are incorporated in and constitute a part of this specification, illustrate an implementation of the invention. The drawings and the description below serve to explain the advantages and principles of the invention. In the drawings,

FIG. 1, consisting of FIGS. 1A-1C, is a series of diagrams illustrating an exemplary quartz laser fusion welding system consistent with an embodiment of the present invention;

FIG. 2 is a diagram illustrating an exemplary movable welding head used to direct laser energy consistent with an embodiment of the present invention;

FIG. 3 is a functional block diagram illustrating components within the exemplary quartz laser fusion welding system consistent with an embodiment of the present invention;

FIG. 4, consisting of FIGS. 4A-4B, is a diagram illustrating a welding zone between quartz objects being laser fusion welded consistent with an embodiment of the present invention; and

FIG. 5 is a flow chart illustrating typical steps for fusion welding a first quartz object to a second quartz object consistent with an exemplary embodiment of the present invention.

### DETAILED DESCRIPTION

Reference will now be made in detail to an implementation consistent with the present invention as illustrated in the accompanying drawings. Wherever possible, the same reference numbers will be used throughout the drawings and the following description to refer to the same or like parts.

In general, methods and systems consistent with the present invention apply laser energy to a quartz workpiece, such as two quartz objects, in order to bring the workpiece to a fusion weldable condition and form a fusion weld between the objects. In order to successfully weld quartz, a careful balance of thermal load at the weldable surface should be maintained in order to create the boundary conditions for the quartz to properly intermingle or fuse on a molecular level and avoid the creation of a cold joint that is improperly fused. Those skilled in the art will appreciate that use of the terms “quartz”, “quartz glass”, “vitreous quartz”, “vitrified quartz”, “vitreous silica”, and “vitrified silica” are interchangeable regarding embodiments of the present invention.

In more detail, when quartz transitions from its solid or “super-cooled liquid” state to the gaseous state, it evaporates or vaporizes. The temperature range between the liquid and gaseous state is somewhere between about 1900 degrees Celsius (C.) and 1970 degrees C. The precise transition temperature varies slightly because of trace elements in the material and environmental conditions. When heated from its solid or super-cooled state to a still super-cooled but very hot, more mobile state, the quartz becomes tacky or thixotropic. Applicants have found that quartz in this state does not cold flow much faster than at lower elevated temperatures and it does not flow (in the sense of sagging) particularly fast but it does become very sticky.

As the temperature approaches the transition range, the thermal properties of quartz change radically. Below 1900 degrees C., the thermal conductivity curve for quartz is fairly flat and linear (positive). However, at temperatures greater than approximately 1900 degrees C. and below the sublimation point, thermal conductivity starts to increase as a third order function. As the quartz reaches a desired temperature associated with the fusion weldable state, applicants have discovered that it becomes a thermal mirror or a very reflective surface.

The quartz thermal conductivity non-linearly increases with thermal input and increasing temperature. There exists a set of variable boundary layer conditions that thermal input influences. This influence changes the depth of the boundary layer. This depth change results in or causes a dramatic shift in the thermal characteristics (coefficients) of various thermal parameters. The cumulative effect of the radical thermal conductivity change is the cause of the quartz material's abrupt change of state. When its heat capacity is saturated, all of the thermal parameters become non-linear at once, causing abrupt vaporization of the material.

This boundary layer phenomenon is further examined and discussed below. The subsurface layers of the quartz workpiece have, to some depth, a coefficient of absorption which is fixed at “Initial Conditions” (IC) described below in Table 1.

TABLE 1

| | |
|---|---|
| Let the coefficient of thermal absorption of laser | k |
| radiation be: | |
| Let the depth of the sub-surface layer be: | d |
| Let the coefficient of heat capacity be: | c |
| Let the coefficient of reflectance be: | r |
| Let the coefficient of thermal conduction be: | λ |
| Let the density be: | ρ |

As the quartz is heated over a temperature range below 1900 degrees C., k increases but with a shallow slope, and d remains relatively constant and fairly large. However, applicants have found that as the temperature exceeds 1900 degrees C., the slope of k increases at a third-order (cubic) rate until it becomes asymptotic with an increase in thermal conductivity. Simultaneously, the depth of sub-surface penetration d decreases similarly. This causes an increase in the thermal gradient within the quartz object that reduces the bulk thermal conductivity but increases it at the thinning boundary layer on the weldable surface of the object.

As a result, the heat energy is concentrated in the boundary layer at the weldable surface. As this concentration occurs, the coefficient of thermal conductivity increases. These dramatic, non-linear, thermal property changes in the boundary layer create a condition where the energy causes the (finite) weldable surface of the quartz object to become quasi-fluid. As explained above, this condition is at the ragged edge of sublimation. A few more calories of heat and the quartz vaporizes. It is within this temperature range and viscosity region that effective quartz fusion welding can occur. The difficulty in attaining these two conditions simultaneously is that (1) in general, heating is a random, generalized process, and (2) heating is not a precisely controllable parameter. Embodiments of the present invention focus on applying laser energy in order to fusion weld quartz objects together.

For optimal fusion welding, it is important to determine how much heat is needed to raise the quartz object's temperature to just under the vaporization or sublimation point. As described in related U.S. patent application Ser. No. 09/516,937, the amount of energy (energy from a laser, or other heat source) that is required to heat a quartz object to its thermal balance point (thermal-equilibrium) is preferably determined prior to applying that energy to the quartz object, which is incorporated by reference. The present application focuses on how the energy is applied to one or more quartz objects that make up a quartz workpiece.

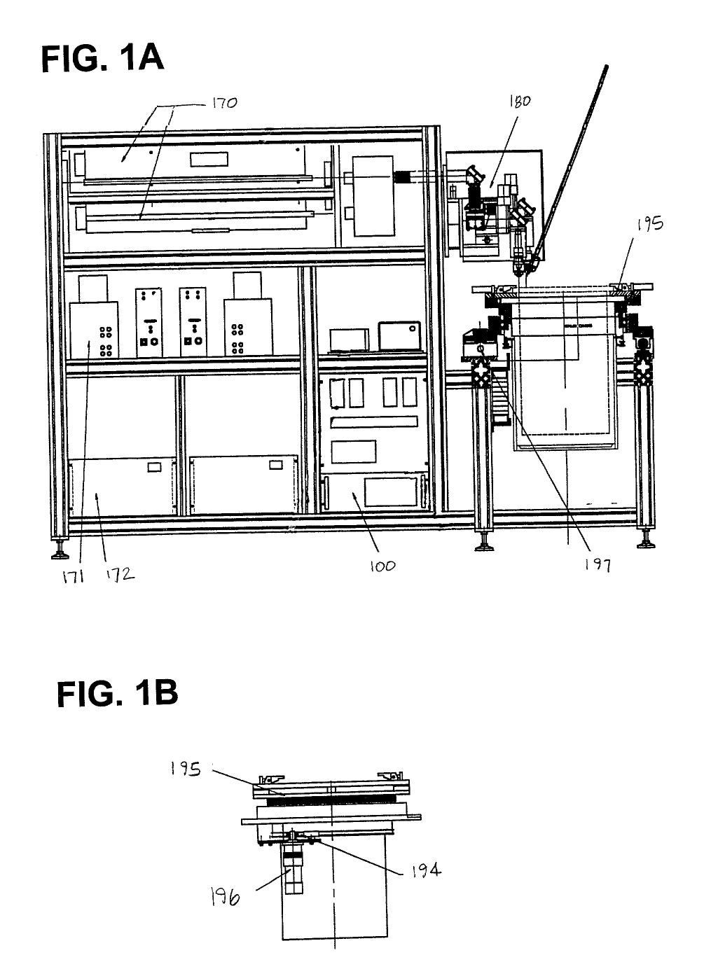

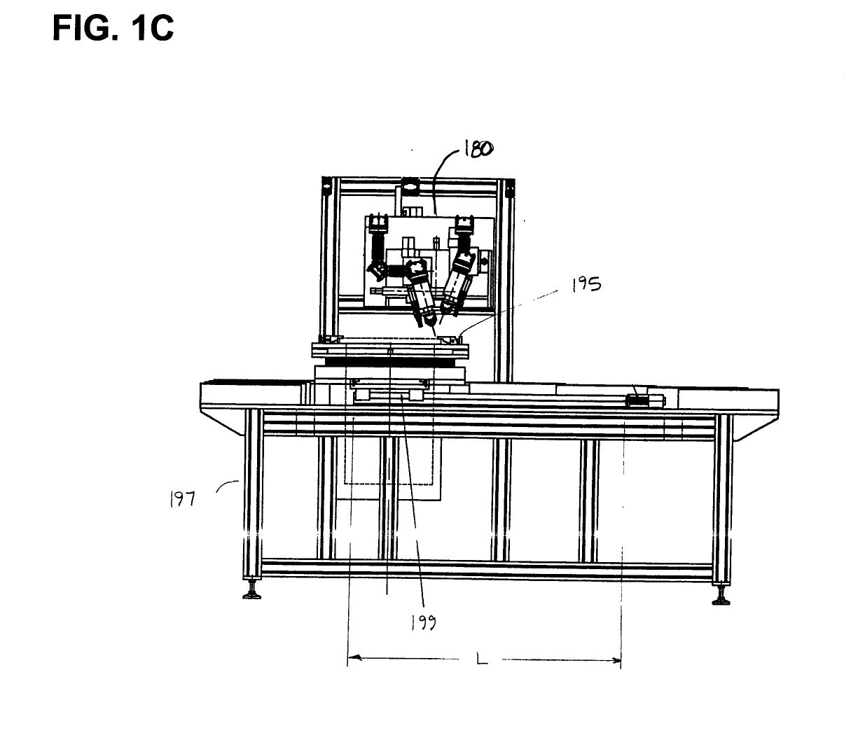

An exemplary quartz fusion welding system is illustrated in FIGS. 1A-C that is suitable for applying laser energy to fusion weld quartz objects consistent with the present invention. FIG. 1A is the front view of such a system. FIG. 1B illustrates the system's movable working surface and FIG. 1C is a side view of the system showing another view of the movable working surface and a movable welding head.

Referring now to FIG. 1A, the exemplary quartz fusion welding system 1 includes a laser energy source 170, a movable welding head 180, a working table 197 having a movable working surface 195, and a computer system 100. While the illustrated system 1 supports the workpiece using working table 197 and movable working surface 195, another embodiment of such a system (not shown) uses a lathe-type support structure for supporting tubular workpieces that are spun around as laser energy is applied. An embodiment of such an alternative system for supporting tubular workpieces is described in U.S. patent application Ser. No. ______ entitled “METHOD AND APPARATUS FOR CONCENTRICALLY FORMING AN OPTICAL PREFORM USING LASER ENERGY”, which is commonly owned and hereby incorporated by reference.

In the illustrated embodiment from FIG. 1A, laser energy source 170 is powered by power supply 171 and cooled using refrigeration system 172. In the exemplary embodiment, laser energy source 170 is one or more sealed Trumpf Laser Model TLF 3000t CO₂ lasers having a predefined wavelength of 10.6 microns. The laser is typically capable of providing 3000 Watts of laser power, has a focal length of 3.75 inches and a focal spot size of 0.2 mm in diameter. Those skilled in the art will appreciate that the lasers may have the same or different characteristics, such as wavelengths (e.g., 355 nm or 3.5 microns), energy levels, or focal characteristics (e.g., focal lengths, spot sizes, etc.), so that when combined the lasers provide a desired heating zone to be applied to the quartz workpiece. Further, those skilled in the art will appreciate that the term “laser” includes systems with terminal optics or may be simply the lasing element per se.

When two quartz objects (not shown) are to be fusion welded, the objects are placed in a pre-weld configuration on movable working surface 195. In general, the pre-weld configuration is a desired orientation of each object relative to each other. More specifically, the pre-weld configuration places a surface of one quartz object proximate to and substantially near an opposing surface of the other quartz object. These two surfaces form a gap or channel between the object where the laser energy is to be applied. Those skilled in the art will appreciate that the pre-weld configuration for any two quartz objects will vary depending upon the desired joining of the objects.

After placement of the quartz objects into the pre-weld configuration, laser energy source 170 provides energy in the form of a laser beam 175 to movable welding head 180 under the control of computer system 100. Movable welding head 180 receives laser beam 175 and directs its energy in a beam 185 to a welding zone between the two quartz objects in accordance with instructions from computer system 100. While it is important to apply laser energy when fusion welding two quartz objects in an embodiment of the present invention, it is desirable that the system have the ability to selectively direct how and where the laser energy is applied relative to the quartz objects themselves. To provide such an ability, the laser energy is applied in a selectable vector (an orientation and magnitude) relative to the quartz objects being fusion welded.

Selecting or changing the vector can be accomplished by moving the laser energy relative to a fixed object or moving the object to be welded relative to a fixed source of laser energy. In the exemplary embodiment, it is preferably accomplished by moving both the quartz objects being welded (by moving and/or rotating the working surface 195 under control of the computer 100) and by moving the vector from which the laser energy is applied (using actuators to move angled reflection joints within movable welding head 180).

FIGS. 1B and 1C are diagrams illustrating views of the exemplary working table 197. Referring now to FIG. 1B, a portion of working table 197 is shown having movable working surface 195 that is rotatable. The working surface 195 rotates in response to commands or signals from computer 100 to rotational actuator 196 (typically implemented as a DC servo actuator). A timing belt 194 connects the output of the DC motor within rotational actuator 196 to the working surface 195. Thus, working surface 195 rotates the configuration of quartz objects being welded that are supported on the working surface 195 of table 197. Furthermore, table 197 includes a linear actuator 199 to provide linear movement along a length (preferably considered an x-axis) of table 197 as shown in FIG. 1C. FIG. 1C illustrates a side view of table 197. The linear actuator 199 preferably moves the working surface 195 (and its rotational actuators and controls) along length L so that the quartz objects being fusion welded are moved relative to movable welding head 180. Thus, working surface 195 is movable in a linear and rotational sense to selectively position the quartz objects relative to the welding head 180.

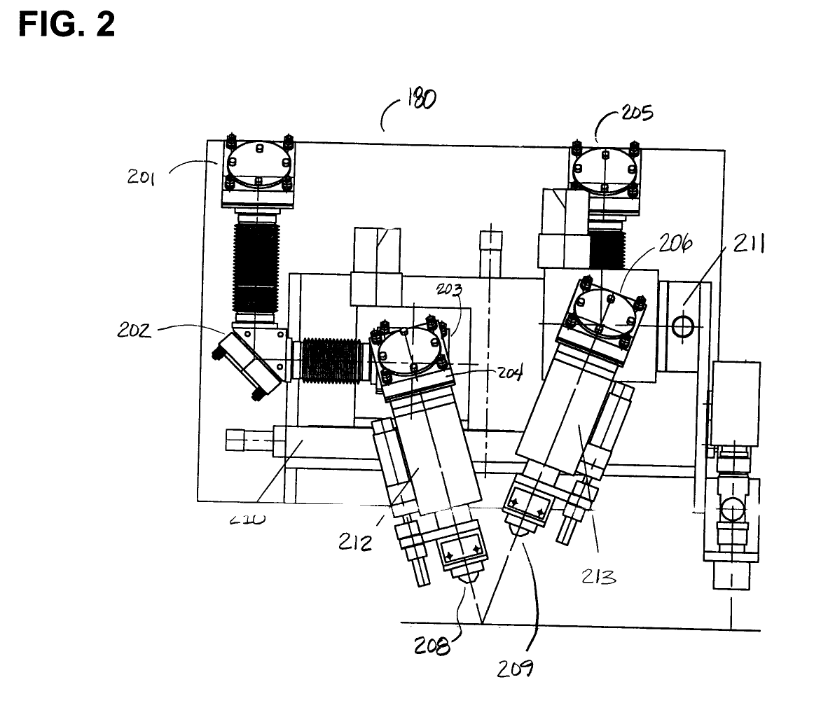

FIG. 2 is a diagram illustrating an exemplary movable welding head used to direct laser energy consistent with an embodiment of the present invention. Referring now to FIG. 2, movable welding head 180 is generally a conduit for directing the laser energy from laser energy source 170 to the welding zone between the quartz objects being welded. In the exemplary embodiment, movable welding head 180 directs laser beams using angled reflective surfaces (e.g., mirrors) within elbows of a reconfigurable arrangement of angled reflection joints. Furthermore, in the exemplary embodiment where laser energy source 170 includes two lasers, the first laser projects a beam that is directed through joint 201, through joint 202, through joint 203, and finally through joint 204 before exiting welding head 180 at output 208. Similarly, the second laser projects another beam of laser energy that is directed through another series of angled reflection joints, namely joints 205, 206, and a joint not shown which is directly behind joint 206, before exiting welding head 180 at output 209. Those skilled in the art will appreciate that the alignment of the directed laser energy depends upon the orientation of each joint and its relative position to the other joints.

In the exemplary embodiment, welding head 180 is movable in relation to the source of laser energy 170. This allows positioning of the welding head 180 to selectively alter where the laser energy is to be applied while using a fixed or stationary source of laser energy. In more detail, welding head 180 includes a series of actuators capable of moving the angled reflection joints relative to each other. For example, welding head 180 includes an x-axis actuator 210 and a y-axis actuator 211. These actuators permit movement of the laser beams directed out of laser outputs 208, 209 in an x- and y-direction, respectively. The z-axis actuator (not shown) is located on the back of welding head 180 and operates similar to actuators 210, 211 in that it permits movement of the laser beams directed out of laser outputs 208, 209 in a z-direction (e.g., up and down). The x-axis actuator 210, y-axis actuator 211, and z-axis actuator (not shown) are preferably implemented using an electronically controllable crossed roller slide having a DC motor and an encoder for sensing the movement.

In the exemplary embodiment where there are two lasers as the laser energy source, welding head 180 may also include a z1-axis actuator 212 and a z2-axis actuator 213. These actuators 212, 213 move the outputs 208, 209 relative to each other and facilitate focusing the beams. The z1-axis actuator 212 and the z2-axis actuator 213 are preferably implemented as electronically controllable linear motorized slides. Such slides also have DC motors for positioning and encoders for sensing position.

Furthermore, in the exemplary embodiment with two lasers as the laser energy source, the laser coupled to output 208 is normally designated a “heating” laser. This is because the beam from output 208 is typically used to pre-heat the quartz being processed. Likewise, the laser coupled to output 209 is designated a “welding” laser because is it usually used to weld the quartz after pre-heating. In an alternative embodiment, it is contemplated that such pre-heating and welding may use only a single laser as the laser energy source.

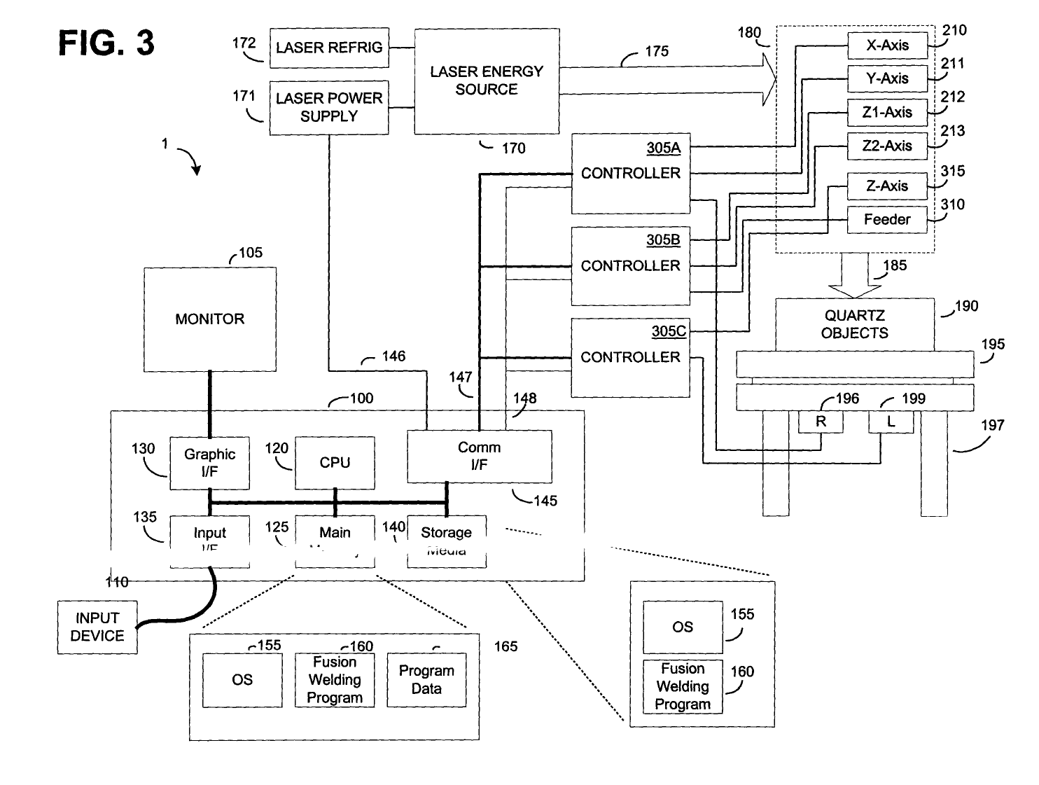

Looking at the exemplary quartz laser fusion welding system 1 in more detail, FIG. 3 is a functional block diagram illustrating components within the exemplary quartz laser fusion welding system consistent with an embodiment of the present invention. Referring now to FIG. 3, computer system 100 sets up and controls laser energy source 170, movable welding head 180, and movable working surface 195 in a precise and coordinated manner during fusion welding of the quartz objects on working surface 195. Computer system 100 typically turns on laser energy source 170 for discrete periods of time. Computer system 100 also controls the positioning of movable welding head 180 and movable working surface 195 relative to the quartz objects being welded so that surfaces on the objects can be easily fusion welded in an automated fashion. As discussed and shown in FIGS. 1B and 1C, movable working surface 195 typically includes actuators allowing it to move along a longitudinal axis (preferably the x-axis) as well as rotate relative to the movable welding head 180.

Looking at computer system 100 in more detail, it contains a processor (CPU) 120, main memory 125, computer-readable storage media 140, a graphics interface (Graphic I/F) 130, an input interface (Input I/F) 135 and a communications interface (Comm I/F) 145, each of which are electronically coupled to the other parts of computer system 100. In the exemplary embodiment, computer system 100 is implemented using an Intel PENTIUM III® microprocessor (as CPU 120) with 128 Mbytes of RAM (as main memory 125). Computer-readable storage media 140 is preferably implemented as a hard disk drive that maintains files, such as operating system 155 and fusion welding program 160, in secondary storage separate from main memory 125. One skilled in the art will appreciate that other computer-readable media may include secondary storage devices (e.g., floppy disks, optical disks, and CD-ROM); a carrier wave received from a data network (such as the global Internet); or other forms of ROM or RAM.

Graphics interface 130, preferably implemented using a graphics interface card from 3Dfx, Inc. headquartered in Richardson, Tex., is connected to monitor 105 for displaying information (such as prompt messages) to a user. Input interface 135 is connected to an input device 110 and can be used to receive data from a user. In the exemplary embodiment, input device 110 is a keyboard and mouse but those skilled in the art will appreciate that other types of input devices (such as a trackball, pointer, tablet, touchscreen or any other kind of device capable of entering data into computer system 100) can be used with embodiments of the present invention.

Communications interface 145 electronically couples computer system 100 (including processor 120) to other parts of the quartz fusion welding system 1 to facilitate communication with and control over those other parts. Communication interface 145 includes a connection 146 (preferably using a conventional I/O controller card) to laser energy source 170 used to setup and control laser energy source 170. In the exemplary embodiment, this connection 146 is to laser power supply 171. However, other embodiments may implement connection 146 directly to laser energy source 170 to control a variety of laser beam parameters (e.g., energy level, selectable wavelength, focal length, spot size, etc.). Those skilled in the art will recognize still other ways in which to connect computer system 100 with other parts of fusion welding system 1, such as through conventional IEEE-488 or GPIB instrumentation connections.

In the exemplary embodiment of the present invention, communication interface 145 also includes an Ethernet network interface 147 and an RS-232 interface 148 for connecting to hardware that implement control systems within movable welding head 180 and movable working surface 195. The hardware implementing such control systems includes controllers 305A, 305B, and 305C. Each controller 305A-C (preferably implemented using Parker 6K4 Controllers) is controlled by computer system 100 via the RS-232 connection and the Ethernet network connection. Communication with the control system hardware through the Ethernet network interface 147 uses conventional TCP/IP protocol. Communication with the control system hardware using the RS-232 interface 148 is typically for troubleshooting and setup.

Looking at the hardware in more detail, controllers 305A-305C control the actuators necessary to selectively apply the laser energy to a surface of a quartz object on the working surface 195 of the table 197. Specifically, controller 305A is configured to provide drive signals to x-axis actuator 210, y-axis actuator 211, and rotational (“R”) actuator 196. Controller 305B is typically configured to provide drive signals to z1-axis actuator 212, z2-axis actuator 213, and a fill rod feeder (“Feeder”) actuator 310 attached to the movable welding head 180. Similarly, controller 305C is configured to provide drive signals to the z-axis actuator 315 and linear (“L”) actuator 199 for linear movement of the working surface 195 of table 197.

Each of the drive signals are preferably amplified by amplifiers (not shown) before sending the signals to control a motor (not shown) within these actuators. Each of the actuators also preferably includes an encoder that provides an encoder signal that is read by controllers 305A-C.

Once computer system 100 is booted up, main memory 125 contains an operating system 155, one or more application program modules (such as fusion welding program 160), and program data 165. In the exemplary embodiment, operating system 155 is the WINDOWS NT™ operating system created and distributed by Microsoft Corporation of Redmond, Wash. While the WINDOWS NT™ operating system is used in the exemplary embodiment, those skilled in the art will recognize that the present invention is not limited to that operating system. For additional information on the WINDOWS NT™ operating system, there are numerous references on the subject that are readily available from Microsoft Corporation and from other publishers.

Fusion Welding Process

In the context of the above described system, fusion welding program 160 causes a specific amount of laser energy to be applied to the quartz objects that are in the pre-weld configuration on table 197 in a controlled manner. This is typically accomplished by manipulating the movable welding head 180 and movable working surface 195. The laser energy is advantageously and uniformly applied to the object surfaces being fusion welded.

As part of setting up to fusion weld two quartz objects together, the quartz objects are placed in their pre-weld configuration and soaked at an initial preheating temperature to help avoid rapid changes in temperature that may induce stress cracks within the resulting fusion weld. In the exemplary embodiment, the preheating temperature is typically between 500 and 700 degrees C. and is preferably applied with a laser. Other embodiments may include no preheating or may involve applying energy for such preheating using other heat sources, such as a hydrogen-oxygen flame.

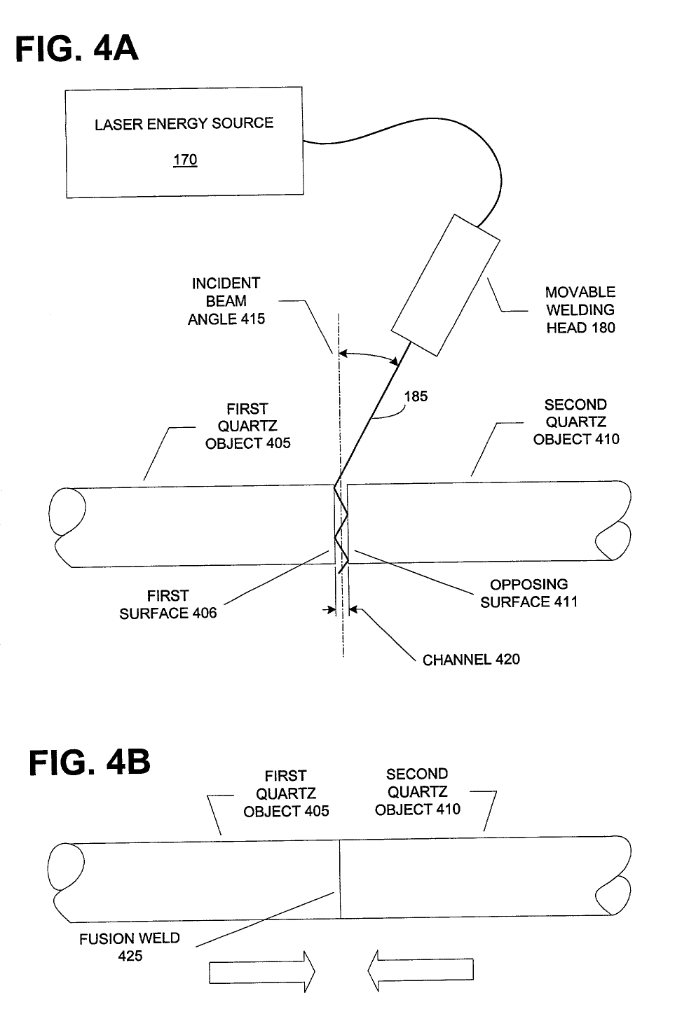

Once preheated, fusion welding program 160 determines how much energy is needed to bring the surfaces of the quartz objects to the desired fusion weldable condition without vaporizing quartz material. Quartz fusion welding system 1 then aligns the source of laser energy by positioning the movable welding head 180 to provide laser beam 185 to a welding zone between the objects being welded. FIGS. 4A and 4B are diagrams illustrating a welding zone between exemplary quartz objects being laser fusion welded consistent with an embodiment of the present invention. Referring now to FIG. 4A, a first quartz object 405 is disposed on movable working surface 195 next to a second quartz object 410 after being preheated. For clarity, the first quartz object 405 and the second quartz object 410 are illustrated as stock quartz rods that have end surfaces 406 and 411, respectively, that are to be fusion welded together. When placing the first quartz object 405 in a pre-weld configuration with the second quartz object 410 before preheating, surface 406 on the first object 405 is placed proximate to and substantially near opposing surface 411 on the second object 410. In this configuration, the end surfaces 406, 411 define a gap or channel 420 between the objects.

After preheating, laser energy source 170 generates laser energy in the form of laser beam 185 that is directed to the welding zone between the objects. Movable welding head 180 operates to align the energy and direct laser beam 185 to end surface 406 of the first object 405. This is typically accomplished by focusing the laser beam at an incident beam angle 415 of 0-10 degrees (this may vary depending on the type, geometry, and character of the material being processed) from the centerline of the channel. While the exemplary environment uses a 0-10 degree incident beam angle when launching laser beam 185 into channel 420, those skilled in the art will realize that there are many cases where different geometries of materials may require a different angle of incidence for the laser beam as it is reflected and distributed along the channel 420. For example, if the first quartz object 405 is a rod, column or other cylindrically shaped object that is being fusion welded to a planar second quartz object (not shown), then the incident beam angle may be from 0-45 degrees above the planar surface. However, under certain configurations of the material being welded, the angle may vary within a range of values from 0-90 degrees.

As surface 406 absorbs the incident laser energy from laser beam 185 and the surface is increasingly heated, the surface 406 becomes shiny and reflective. In other words, as the surface 406 approaches a fusion weldable condition, the quartz surface 406 reaches a reflective state. In this reflective state, surface 406 bounces or transfers the energy of the laser beam 185 to opposing surface 411. As a result, opposing surface 411 also reaches the reflective state and laser beam 185 is repeatedly reflected down the length of channel 420 heating surfaces 406 and 411 to a substantially uniform or even distribution. This advantageously allows for precise and substantially even heating of surfaces deep within channel 420. Once the surfaces to be welded reach the reflective state and distribute the heat, the surfaces reach a fusion weldable condition so that the surfaces will molecularly fuse together to form a fusion weld.

FIG. 4B is a diagram illustrating the first object 405 after it is fusion welded to the second object 410. The reflected laser energy has heated both end surfaces to reach a fusion weldable condition and then both objects were joined together in a fusion weld 425 where the molecules from the first object 405 become intermingled with the molecules of the second object 410. Those skilled in the art will appreciate that causing the objects to join and then fuse may be due to gravity or due to an applied compressive force.

Additionally, those skilled in the art will appreciate that it is possible to use a glass fill rod to fill in channel 420 and complete the fusion weld. Essentially, the fill rod is fed into the channel as the surfaces in the channel are heated.

While fusion weld 425 is illustrated as a visible line in FIG. 4B, those skilled in the art will also appreciate that the resulting fusion welded quartz will be a singular object with no visible seam, crack or demarcation to show the weld.

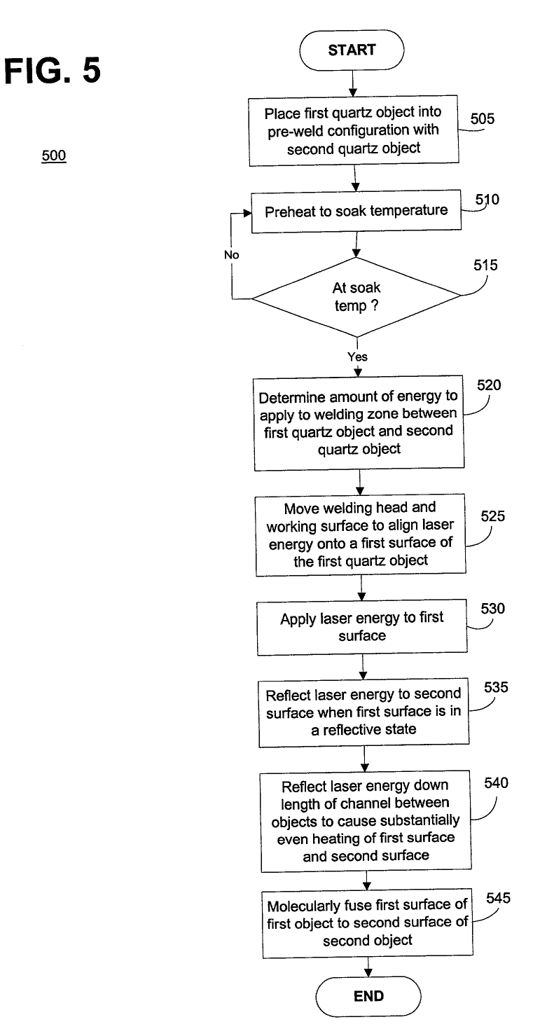

In the context of the above description and information, further details on steps of an exemplary method consistent with the present invention for fusion welding a first quartz object to a second quartz object will now be explained with reference to the flowchart of FIG. 5. Referring now to FIG. 5, the method 500 begins at step 505 where a first quartz object is placed in a pre-weld configuration next to a second quartz object. The exact configuration depends upon which of their respective surfaces are to be fusion welded together. In the exemplary embodiment, the first object is placed proximate to and substantially near the second object so that a surface on the first object and an opposing surface on the second object form a narrow gap or channel.

At step 510, the configuration of quartz objects (also referred to as a quartz workpiece) is preheated to a predetermined soak or preheating temperature. In the exemplary embodiment, the preheating temperature is typically between 500 and 700 degrees C. and is preferably applied with a laser. Depending upon the dimensions of the quartz objects, the dimensions of the surfaces to be fusion welded, and the power of the laser, the time it takes to reach the soaking temperature will vary. In the exemplary embodiment, the laser is used to preheat the area immediately next to each side of the weld line or cutting line path to include the faces of the channel as much as possible. This area is roughly analogous to the “heat affected zone” on a conventionally welded metal body. This area can be characterized as the margin of the weld channel.

At step 515, if the configuration of quartz objects has reached the soaking temperature, then step 515 will proceed directly to step 520. Otherwise, step 515 will continue to preheat at step 510.

At step 520, an amount of heat is determined that is needed to apply to the welding zone between the first and second object. In the exemplary embodiment, this determination is preferrably accomplished in accordance with steps and methods described in U.S. patent application Ser. No. 09/516,937.

At step 525, the parts of the welding system are aligned and moved (such as the welding head and/or the working surface having the quartz objects) so that laser energy can be provided to a first surface of the first object. In the exemplary embodiment, the laser energy is generated by two laser beams that are directed and focused upon the first surface by movable welding head 180 and movable working surface 195.

At step 530, the laser energy is applied to the first surface on the first object. As the first surface (or at least a portion of the first surface) begins to heat up and reach an energy reflective or shiny state, the laser energy is reflected to a second surface on the second object in step 535. Upon reflecting off the first surface to the second surface, the second surface (or at least a portion of the second surface) is heated to the reflective state. At step 540, reflections of the laser energy are bounced down the channel between the first and second surfaces. This causes substantially even heating of the rest of the first and second surfaces to a fusion weldable condition. Once heated in this fashion, the first surface and the second surface can molecularly fuse to each other at step 545 forming a fusion weld between the quartz objects. Typically, this is accomplished by causing the objects to contact each other when in the desired fusion weldable condition.

Those skilled in the art will appreciate that embodiments consistent with the present invention may be implemented in a variety of technologies and that the foregoing description of an implementation of the invention has been presented for purposes of illustration and description. It is not exhaustive and does not limit the invention to the precise form disclosed. Modifications and variations are possible in light of the above teachings or may be acquired from practicing of the invention. While the above description encompasses one embodiment of the present invention, the scope of the invention is defined by the claims and their equivalents.

What is claimed is:

1. A method for fusion welding a first quartz object to a second quartz object, comprising:
applying laser energy to the first quartz object and the second quartz object to heat the first quartz object and the second quartz object; and
forming a fusion weld between the heated first quartz object and the heated second quartz object.

2. The method of claim 1, wherein the applying step further comprises applying a plurality of laser beams as the laser energy.

3. The method of claim 1, wherein the applying step further comprises applying the laser energy until the first quartz object and the second quartz object are in a fusion weldable condition.

4. The method of claim 3, wherein the fusion weldable condition is an energy reflective state substantially near but below a sublimation point for the first quartz object and the second quartz object.

5. The method of claim 1 further comprising the step of directing the laser energy to a welding zone between the first quartz object and the second quartz object.

6. The method of claim 5, wherein the directing step further comprises positioning a movable welding head relative to the first quartz object and the second quartz object, the movable welding head being coupled to a source of the laser energy and being capable of directing the laser energy from the source towards the welding zone.

7. A method for fusion welding a first quartz object to a second quartz object, comprising:
applying laser energy to the first quartz object; and
bouncing the laser energy between the first quartz object and the second quartz object to cause the first quartz object and the second quartz object to form a fusion weld.

8. The method of claim 7, wherein the step of applying further comprises applying a beam of the laser energy to the first quartz object to bring the first quartz object to a reflective state.

9. The method of claim 8, wherein the applying step further comprises heating the first quartz object to a state substantially near a sublimation point for the first quartz object.

10. The method of claim 7, wherein the bouncing step further comprises reflecting the laser energy to the second quartz object.

11. The method of claim 10, wherein the reflecting step further comprises reflecting the laser energy from the first quartz object to the second quartz object while the first quartz object is in a energy reflective state.

12. The method of claim 10 further comprising bringing the second quartz object to the energy reflective state.

13. A method for fusion welding a first quartz object to a second quartz object, comprising:
applying laser energy to a first surface on the first quartz object, the first surface being placed proximate to and substantially near a second surface on the second quartz object;
transferring the laser energy from the first surface to the second surface when the first surface reaches a reflective state;
heating the second surface to the reflective state; and
causing the first surface and the second surface to contact each other to form a fusion weld between the first quartz object and the second quartz object.

14. The method of claim 13 further comprising, prior to the applying step, positioning a movable welding head relative to the first surface, the movable welding head being coupled to a source of the laser energy and being capable of directing the laser energy onto the first surface.

15. The method of claim 13, wherein the applying step further comprises heating the first surface to the reflective state.

16. The method of claim 13, wherein the transferring step further comprises reflecting the laser energy to the second surface.

17. A fusion welding apparatus for welding a first quartz object to a second quartz object, comprising:
a laser energy source oriented to apply laser energy to a channel between the first quartz object and to the second quartz object and cause the laser energy to be reflected within the channel between the first quartz object and the second quartz object when forming a fusion weld between the first quartz object and the second quartz object.

18. The fusion welding apparatus of claim 17 further comprising a welding head coupled to receive the laser energy from the laser energy source, the welding head being operative to direct the laser energy to a first surface on the first quartz object.

19. The fusion welding apparatus of claim 18, wherein the welding head is selectively movable relative to the first quartz object and the second quartz object.

20. The fusion welding apparatus of claim 17, further comprising a working surface for supporting the first quartz object relative to the laser energy source, the working surface being selectively movable relative to the laser energy as it is applied from the laser energy source.

21. The fusion welding apparatus of claim 17, wherein the laser energy source is further operative to apply enough of the laser energy to heat a first surface of the first quartz object to and an opposing surface of the second quartz object to a desired fusion weldable condition.

22. The fusion welding apparatus of claim 21, wherein the desired fusion weldable condition is an energy reflective state substantially near but below a sublimation point for the first quartz object and the second quartz object.

23. A method for fusion welding a first quartz object to a second quartz object, comprising the steps of:
creating a pre-weld configuration of the first quartz object and the second object by placing a first surface of the first quartz object proximately to and substantially near an opposing surface of the second quartz object to form a channel between the first surface and the opposing surface;
aligning a source of laser energy to provide the laser energy to the first surface within the channel;
applying the laser energy to the first surface within the channel;
repeatedly reflecting the laser energy between the first surface and the opposing surface in the channel to cause substantially even heating of the first surface and the second surface as the laser energy is distributed along a length of the channel; and
causing the first surface and opposing surface to molecularly fuse and form a fusion weld in place of the channel.
